(19) United States
(12) Patent Application Publication
(10) Pub. No.: US 2015/0220506 A1
(43) Pub. Date: Aug. 6, 2015

(54) Remote Document Annotation

(71) Applicant: Kopin Corporation, Westborough, MA (US)

(72) Inventors: Christopher Parkinson, Richland, WA (US); Jeffrey J. Jacobsen, Hollister, CA (US); Luke Hopkins, Notthinghamshire (GB); James Woodall, Notthinghamshire (GB); William Connell, Notthinghamshire (GB)

(21) Appl. No.: 14/614,768

(22) Filed: Feb. 5, 2015

Related U.S. Application Data
(60) Provisional application No. 61/935,943, filed on Feb. 5, 2014.

(51) Int. Cl. G06F 17/24; G06F 17/21

(52) U.S. Cl. CPC G06F 17/241; G06F 17/212

(57) ABSTRACT

A system for communicating document annotations includes a host computing platform having a first processor and a transmitter for transmitting information. The system further includes a head mounted display device having a second processor, a micro-display driven by the second processor and a receiver for receiving information from the remote host. The information from the remote host includes information representative of a document and information representative of one or more annotations. The second processor combines the information representative of a document with the information representative of one or more annotations to produce an annotated document, and displays the annotated document on the micro-display.

### RELATED APPLICATION(S)

This claims the benefit of U.S. Provisional Application No. 61/935,943, filed on Feb. 5, 2014. The entire teachings of the above application are incorporated herein by reference.

### BACKGROUND OF THE INVENTION

Mobile computing devices, such as notebook PC's, smart phones, and tablet computing devices, are now common tools used for producing, analyzing, communicating, and consuming data in both business and personal life. Consumers continue to embrace a mobile digital lifestyle as the ease of access to digital information increases with high-speed wireless communications technologies becoming ubiquitous. Popular uses of mobile computing devices include displaying large amounts of high-resolution computer graphics information and video content, often wirelessly streamed to the device.

While these devices typically include a display screen, the preferred visual experience of a high-resolution, large format display cannot be easily replicated in such mobile devices because the physical size of such device is limited to promote mobility. Another drawback of the aforementioned device types is that the user interface is hands-dependent, typically requiring a user to enter data or make selections using a keyboard (physical or virtual) or touch-screen display. As a result, consumers are now seeking a hands-free high-quality, portable, color display solution to augment or replace their hands-dependent mobile devices.

### SUMMARY OF THE INVENTION

Recently developed micro-displays can provide large-format, high-resolution color pictures and streaming video in a very small form factor. One application for such displays can be integrated into a wireless headset computer worn on the head of the user with a display within the field of view of the user, similar in format to eyeglasses, audio headset or video eyewear. A “wireless computing headset” device includes one or more small high-resolution micro-displays and optics to magnify the image. The WVGA micro-displays can provide super video graphics array (SVGA) (800×600) resolution or extended graphic arrays (XGA) (1024×768) or even higher resolutions. A wireless computing headset contains one or more wireless computing and communication interfaces, enabling data and streaming video capability, and provides greater convenience and mobility through hands dependent devices. For more information concerning such devices, see co-pending patent applications entitled “Mobile Wireless Display Software Platform for Controlling Other Systems and Devices,” U.S. application Ser. No. 12/348,648 filed Jan. 5, 2009, “Handheld Wireless Display Devices Having High Resolution Display Suitable For Use as a Mobile Internet Device,” PCT International Application No. PCT/US09/38601 filed Mar. 27, 2009, and “Improved Headset Computer,” U.S. Application No. 61/638,419 filed Apr. 25, 2012, each of which are incorporated herein by reference in their entirety.

As used herein, headset computer (“HSC”), head mounted display device (“HMD”), and “wireless computing headset” device may be used interchangeably.

The described embodiments facilitate a user, equipped with an HMD, to view an image (e.g., a document, a photograph, etc.) sent from a remotely-located user over a communications link (e.g., an Internet (IP) connection). The remote user can annotate the image in real-time (i.e., live annotation), which the HMD-equipped user can see.

When workers are engaged in fieldwork, such as maintenance repair, the workers may require access to information and support to resolve a problem. Such information and support may be provided through remote document annotation, which allows for a HMD-equipped user to clearly identify the nature and location of a problem through visual guidance from a remote user.

Through remote annotation, a remote user can provide input, such as visual hints or guides, to the HMD-equipped user to help the HMD-equipped user complete a task. The remote user can provide the hints or guides by directly drawing over a document or image on a tablet, smartphone, workstation or other computing device known in the art. The remote user can draw on the computing device with, for example, a stylus or their fingers, in order to convey these visual hints to the HMD-equipped user. The remote user can also convey comments or footnotes to the HMD-equipped user by using text fields to write text over the document or image. The HMD user receives and views (in real-time) the annotations sent by the remote user. Real-time audio communications between the users may be combined with the visual annotation communications.

The described embodiments may consist of two applications. One application runs on the HMD device and acts as a listener (i.e., a receiver) and the other application acts as sender (i.e., a transmitter) on the tablet.

In one aspect, the invention may be a device for receiving and viewing document annotations, including a processor of a headset computer, and a micro-display driven by the processor and coupled to the headset computer. The device may further include a receiver, coupled to the processor, configured to receive information from a remote host. The information from the remote host may include information representative of a document and information representative of one or more annotations. The processor may be configured to combine the information representative of a document with the information representative of one or more annotations to produce an annotated document, and display the annotated document on the micro-display.

In one embodiment, the receiver periodically receives query messages from the remote host, and a transmitter sends a reply message to the remote host in response to each of the query messages. In another embodiment, upon receiving the information representative of a document, a transmitter conveys a decision to accept or decline the image data to the remote host. In another embodiment, the information representative of one or more annotations includes at least one of coordinate information, color information, line width information and text information.

One embodiment further includes an audio speaker. The information from the remote host further includes audio information associated with the annotation.

Another embodiment further includes a transmitter configured to transmit the annotated document to a local host. In another embodiment, the receiver is further configured to receive a locally annotated version of the annotated document from the local host.

In one embodiment, the information from the remote host further includes one or more packet updates for supplementing initially-received information.

In another aspect, the invention may be a computer-assisted method of remote document annotation, including selecting, at a host computing platform, a document to be annotated, and providing, at the host computing platform, one or more annotations to the document. The method may further include submitting, at the host computing platform, a location identifier of a desired recipient of the document, and transmitting, by the host computing platform, information representative of the document and information representative of the one or more annotations, to a head mounted display device associated with the location identifier. The method may further include receiving, by the head mounted display device, the information representative of the document and the information representative of the one or more annotations. The method may further include applying, by the head mounted display device, the information representative of the one or more annotations to the document, so as to recreate the one or more annotations provided at the host computing platform. The method may further include displaying, by the head mounted display device, the document together with the annotations.

One embodiment further includes periodically transmitting, by the host computing platform, a query message to the head mounted display device.

Another embodiment further includes receiving, by the head mounted display device, the query message from the host computing platform, and transmitting, by the head mounted display device, a reply message to the host computing platform in response to the query message.

Another embodiment further includes conveying, by the head mounted display device to the host computing platform, a decision to accept the information representative of the document.

One embodiment further includes transmitting the annotated document to a local host. Another embodiment further includes receiving a locally annotated version of the annotated document from the local host. Another embodiment further includes conveying, by the head mounted display device to the host computing platform, a decision to decline the information representative of the document.

In another aspect, the invention may be a system for communicating document annotations, including a host computing platform. The host computing platform may include a first processor, and a transmitter, coupled to the first processor, for transmitting information. The system for communicating document annotations may also include a head mounted display device. The head mounted display device may include a second processor, a micro-display driven by the second processor, and a receiver, coupled to the second processor, for receiving information from the remote host. The information from the remote host may include information representative of a document and information representative of one or more annotations. The second processor may combine the information representative of a document with the information representative of one or more annotations to produce an annotated document, and displays the annotated document on the micro-display.

In another aspect, the invention may be a non-transitory computer-readable medium with computer code instructions stored thereon. The computer code instructions when executed by an a processor, may cause a head mounted display device to receive information representative of (i) a document and (ii) one or more annotations. The computer code instructions may further cause the head mounted display device to apply the information representative of the one or more annotations to the document, so as to recreate the one or more annotations provided at the host computing platform;

The computer code instructions may further cause the head mounted display device to display the document together with the annotations. The computer code instructions may further cause the head mounted display device to transmit the annotated document to a local host. The computer code instructions may further cause the head mounted display device to receive a locally annotated version of the annotated document from the local host.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIGS. 1A-1B are schematic illustrations of a headset computer cooperating with a host computer (e.g., Smart Phone, laptop, etc.) according to principles of the present invention.

FIG. 2 is a block diagram of flow of data and control in the embodiment of FIGS. 1A-1B.

FIG. 3 is a block diagram of ASR (automatic speech recognition) subsystem in embodiments.

FIG. 4 shows an example of an annotation canvas at the host, from the point of view of a remote user in embodiments.

FIG. 5 illustrates an example of a remote user annotating an image at the remote host in embodiments.

FIG. 6 illustrates the annotated document as seen from the point of view of the HMD-equipped user in embodiments.

### DETAILED DESCRIPTION OF THE INVENTION

A description of example embodiments of the invention follows.

The teachings of all patents, published applications and references cited herein are incorporated by reference in their entirety.

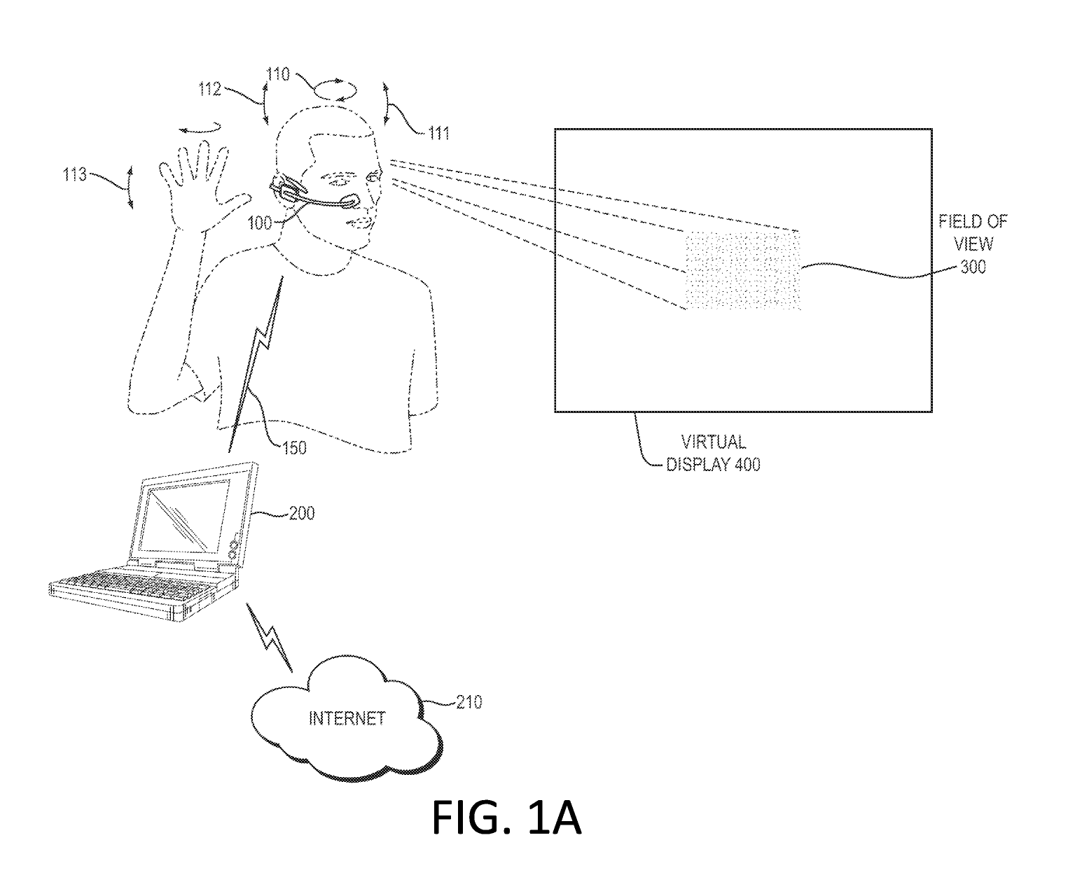

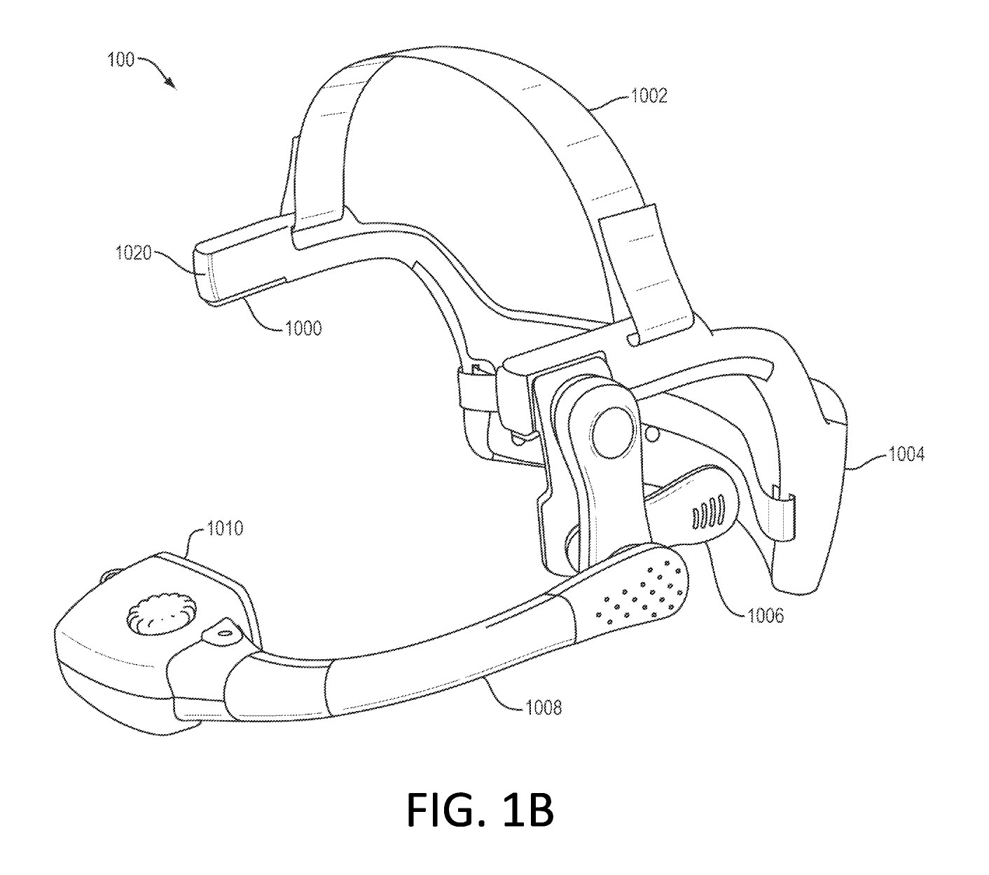

FIGS. 1A and 1B show an example embodiment of a wireless computing headset device 100 (also referred to herein as a head mounted display (HMD) or headset computer (HSC)) that incorporates a high-resolution (VGA or better) micro-display element 1010, and other features described below. HMD 100 can include audio input and/or output devices, including one or more microphones, input and output speakers, geo-positional sensors (GPS), three to nine axis degrees of freedom orientation sensors, atmospheric sensors, health condition sensors, digital compass, pressure sensors, environmental sensors, energy sensors, acceleration sensors, position, attitude, motion, velocity and/or optical sensors, cameras (visible light, infrared, etc.), multiple wireless radios, auxiliary lighting, rangefinders, or the like and/or an array of sensors embedded and/or integrated into the headset and/or attached to the device via one or more peripheral ports 1020 (shown in FIG. 1B). Typically located within the housing of HMD 100 are various electronic circuits including, a microcomputer (single or multicore processors), one or more wired and/or wireless communications interfaces, memory or storage devices, various sensors and a peripheral mount or mount, such as a “hot shoe.”

Example embodiments of the HMD 100 can receive user input through sensing voice commands, head movements, 110, 111, 112 and hand gestures 113, or any combination thereof. Microphone(s) operatively coupled or preferably integrated into the HMD 100 can be used to capture speech commands which are then digitized and processed using automatic speech recognition techniques. Gyroscopes, accelerometers, and other micro-electromechanical system sensors can be integrated into the HMD 100 and used to track the user's head movement 110, 111, 112 to provide user input commands. Cameras or other motion tracking sensors can be used to monitor a user's hand gestures 113 for user input commands. Such a user interface overcomes the hands-dependent formats of other mobile devices.

The HMD 100 can be used in various ways. It can be used as a remote display for streaming video signals received from a remote host computing device 200 (shown in FIG. 1A). The host 200 may be, for example, a notebook PC, smart phone, tablet device, or other computing device having less or greater computational complexity than the wireless HMD 100, such as cloud-based network resources. The host 200 may be further connected to other networks 210, such as the Internet. The HMD 100 and host 200 can wirelessly communicate via one or more wireless protocols, such as Bluetooth®, Wi-Fi, WiMAX, 4G LTE or other wireless interface 150. (Bluetooth is a registered trademark of Bluetooth Sig, Inc. of 5209 Lake Washington Boulevard, Kirkland, Wash. 98033.) In an example embodiment, the host 200 may be further connected to other networks, such as through a wireless connection to the Internet or other cloud-based network resources, so that the host 200 can act as a wireless relay. Alternatively, some example embodiments of the HMD 100 can wirelessly connect to the Internet and cloud-based network resources without the use of a host wireless relay.

FIG. 1B is a perspective view showing some details of an example embodiment of a HMD 100. The example embodiment HMD 100 generally includes, a frame 1000, strap 1002, rear housing 1004, speaker 1006, cantilever, or alternatively referred to as an arm or boom 1008 with a built in microphone, and a micro-display subassembly 1010.

A head worn frame 1000 and strap 1002 are generally configured so that a user can wear the HMD 100 on the user's head. A housing 1004 is generally a low profile unit which houses the electronics, such as the microprocessor, memory or other storage device, along with other associated circuitry. Speakers 1006 provide audio output to the user so that the user can hear information. Micro-display subassembly 1010 is used to render visual information to the user. It is coupled to the arm 1008. The arm 1008 generally provides physical support such that the micro-display subassembly is able to be positioned within the user's field of view 300 (FIG. 1A), preferably in front of the eye of the user or within its peripheral vision preferably slightly below or above the eye. Arm 1008 also provides the electrical or optical connections between the micro-display subassembly 1010 and the control circuitry housed within housing unit 1004.

According to aspects that will be explained in more detail below, the HMD 100 allows a user to select a field of view 300 within a much larger area defined by a virtual display 400. The user can typically control the position, extent (e.g., X-Y or 3D range), and/or magnification of the field of view 300.

While what is shown in FIG. 1A and FIG. 1B is a monocular micro-display presenting a single fixed display element supported on the face of the user with a cantilevered boom, it should be understood that other mechanical configurations for the HMD 100 are possible.

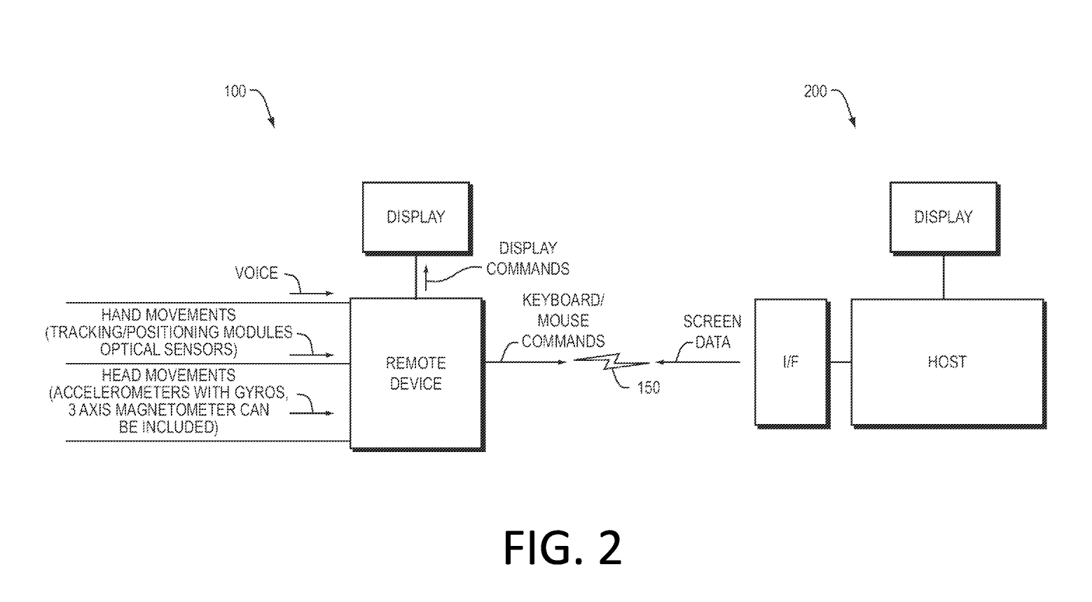

FIG. 2 is a block diagram showing more detail of the HMD 100, host 200 and the data that travels between them. The HMD 100 receives vocal input from the user via the microphone, hand movements or body gestures via positional and orientation sensors, the camera or optical sensor(s), and head movement inputs via the head tracking circuitry such as 3 axis to 9 axis degrees of freedom orientational sensing. These are translated by software (e.g., executed by one or more processors) in the HMD 100 into keyboard and/or mouse commands that are then sent over the Bluetooth or other wireless interface 150 to the host 200. The host 200 then interprets these translated commands in accordance with its operating system/application software to perform various functions. Among the commands is one to select a field of view 300 within the virtual display 400 and return that selected screen data to the HMD 100. Thus, it should be understood that a very large format virtual display area might be associated with application software or an operating system running on the host 200. However, only a portion of that large virtual display area 400 within the field of view 300 may be returned to and actually displayed by the micro display 1010 of HSC or HMD device 100.

In this sense therefore, the amount of data to be transmitted over the wireless interface 150 may be small. For example, data transmitted over the wireless interface may simply include instructions on how to lay out a screen, which text to display, stylistic information such as drawing arrows, background colors, or which images to include.

Additional data could be streamed over the same wireless interface 150 or another connection and displayed on screen 1010, such as a video stream if required by the host 200.

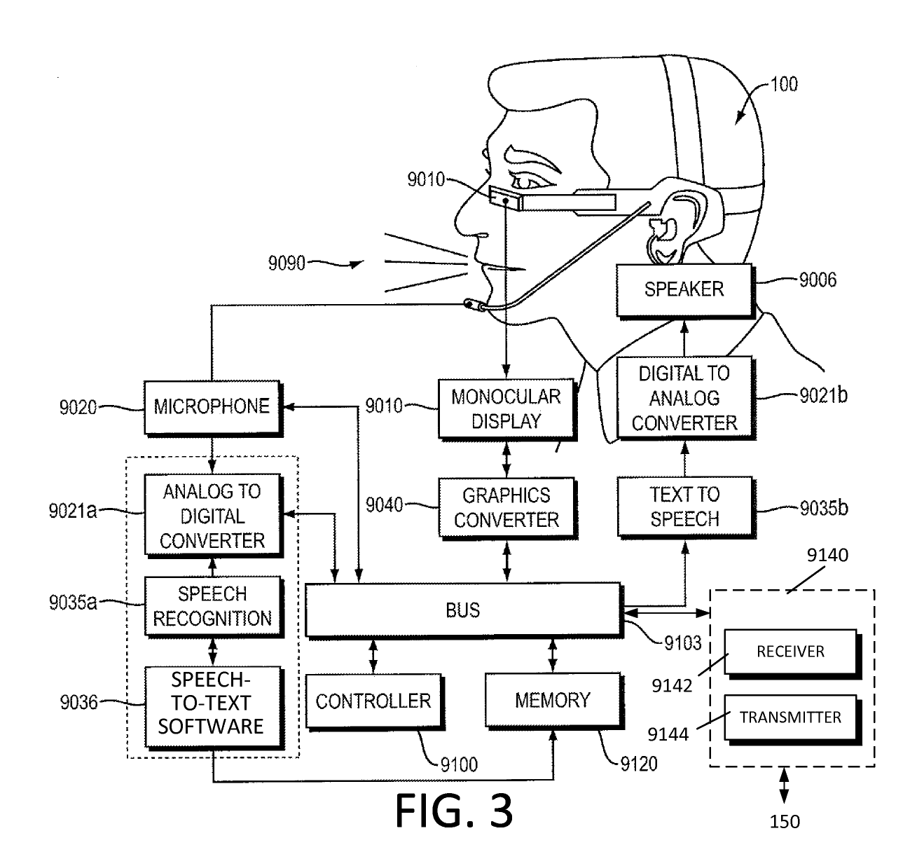

FIG. 3 depicts an exemplary non-limiting wireless hands-free video computing headset (i.e., HMD) 100 under voice command. The user can be presented with an image on the micro-display 9010, for example, as output by host 200. An HMD-equipped user can use speech-to-text software module 9036, either locally or from a remote host 200, in which the user is presented with an image of a message box, text box or dialogue box requesting user input on the micro-display 9010 and the audio of the same through the speaker 9006 of the headset computer 100. Because the headset computer 100 is also equipped with a microphone 9020, the user can utter the subject command selection.

The schematic diagram of FIG. 3 illustrates some of the modules of the HMD 100. FIG. 3 includes a schematic diagram of the operative modules of the HMD 100. For the case of speech recognition processing, controller 9100 accesses speech-to-text module 9036, which can be located locally to each HMD 100 or located remotely at a host 200 (FIG. 1A). Speech-to-text software module 9036 contains instructions to display to a user an image of processed text (e.g. dictation transcription) and menus (or navigation and other prompts). The graphics converter module 9040 converts the image instructions received from the module 9036 via bus 9103 and converts the instructions into graphics to display on the monocular display 9010. At the same time text-to-speech module 9035b converts instructions received from speech-to-text software module 9036 to create sounds representing the contents for the image to be displayed. The instructions are converted into digital sounds representing the corresponding image contents that the text-to-speech module 9035b feeds to the digital-to-analog converter 9021b, which in turn feeds speaker 9006 to present the audio to the user. Speech processing software module 9036 can be stored locally at memory 9120 or remotely at a host 200 (FIG. 1A). The user can speak/utter dictation and/or command selection and the user's speech 9090 is received at microphone 9020. The received speech is then converted from an analog signal into a digital signal at analog-to-digital converter 9021a. Once the speech is converted from an analog to a digital signal speech recognition module 9035a processes the speech into recognized speech. The recognized speech is compared against known speech and processed into text according to instructions of speech-to-text module 9036.

HMD 100 further includes a transceiver module 9140 coupled to bus 9130 and wireless interface 150. The transceiver module may be connected to the controller 9100 or other processors within the HMD 100 through bus 9130 or directly. The transceiver module 9140 includes a receiver 9142 for receiving information from the wireless interface 150 and a transmitter 9144 for transmitting information to the wireless interface 150.

In an exemplary embodiment, the HMD 100 may incorporate operating system (OS) software that is stored as executable code in the HMD memory 9120 and executed by the controller 9100 (also referred to herein as a “processor”). An example of such an operating system is the Golden-i operating system (Gi-OS). The OS may include a document viewer component that provides a user of the HMD 100 with features such as zoom level controls, head-tracker control to pan around the document and the ability to freeze the document at a certain location.

The HMD 100 may further include a remote annotation utility that cooperates with the document viewer. The remote annotation utility may be software stored as executable code in memory 9120 and executed by controller 9100. Remote documents and/or annotations are sent as messages to the HMD 100 from secondary devices.

The cooperation between the OS document viewer component and the remote annotation utility gives the user of the HMD 100 access to all of the features of the document viewer while the user of the HMD 100 reviews documents and/or annotations from the remote user. The user of the HMD 100 consequently has very little to think about in order to see and control the document and/or annotations that are sent from the remote user.

The described embodiments may consist of two applications. A first application runs on the host 200 and primarily functions as a transmitter of information to the second application, although the first application may also receive certain information conveyed by the second application. The first application may be software stored as executable code on memory resources of the host 200.

A second application runs on the HMD 100 and primarily functions as a receiver of information from the first application, although the second application may also convey certain information to the first application. The second application may be software stored as executable code in memory 9120 and executed by controller 9100.

The first application at the host 200 initiates communication (also referred to herein as a ‘call’) between the host 200 and the HMD 100 when the first application receives location information associated with the HMD 100. For example, a remote user at the host 200 may enter an IP address associated with the HMD 100 at the host 200. The location information associated with the HMD 100 may also be accompanied by an initiation command (e.g., the remote user may press a ‘send’ button after entering the IP address).

A handshaking protocol may be used to determine the current connection state between the host 200 and the HMD 100. In one embodiment, the handshaking protocol is a type of “question and answer” exchange in which the host 200 periodically sends a query message to the HMD 100 (e.g., once per minute, although other message frequencies may alternatively be used). The HMD 100 may respond by sending a reply message back to the host 200 to indicate that the query message was received. This exchange may be referred to as a “Ping-Pong” exchange, as the messages are sent back and forth to indicate to both ends of the wireless interface 150 that a connection across the wireless interface 150 is active, even when no other information is being conveyed.

Once a Ping-Pong exchange has been established, the host 200 may send image data to the HMD 100. In one embodiment, the image data is in JPEG format, although other image formats known in the art may alternatively be used. The host 200 may also send additional information to the HMD 100, such as coordinate information, color information, line width information and text information. This additional information may relate to annotations of the image data.

When the HMD 100 receives image data from the host 200, the HMD 100 indicates such to the HMD-equipped user. The indication may include a dialog pop-up on the micro-display 9010, 1010, although other embodiments may alternatively use other modes of indication known in the art. The HMD-equipped user can accept or decline the image data from the host by, for example, a verbal command, a gesture, or other input to HMD 100 available to the user. In one embodiment, the HMD 100 indicates the HMD user decision to accept or decline the image data to the host 200 regardless of the decision. In another embodiment, the HMD 100 only indicates a decision to decline the image data, such that the host 200 interprets a lack of response from the HMD 100 as a decision to accept the image data.

If the HMD-equipped user accepts the image data from the host 200, the HMD 100 establishes a remote annotation session. The HMD 100 provides the HMD user with access to the OS document viewer component, which displays the image data sent from the host 200.

Once the HMD-equipped user has access to the image data, the HMD 100 monitors the wireless interface 150 for additional information such as coordinate information, color information, line width information and text information. In this exemplary embodiment, the additional information is conveyed through “packet updates,” although other techniques for conveying information may also be used. The packet updates add information to the information received initially from the remote host.

Disposition of the packet updates depends on the nature of the information contained within the packet. For example, if a packet update contains text, coordinates and color, then the HMD 100 draws a text field on the displayed image using associated coordinates for positioning the text field and associated color to set the color of the text.

Similarly, if the packet update contains information about coordinates, line width and color, then a line will be drawn on the displayed image based on the coordinates, the color and width information.

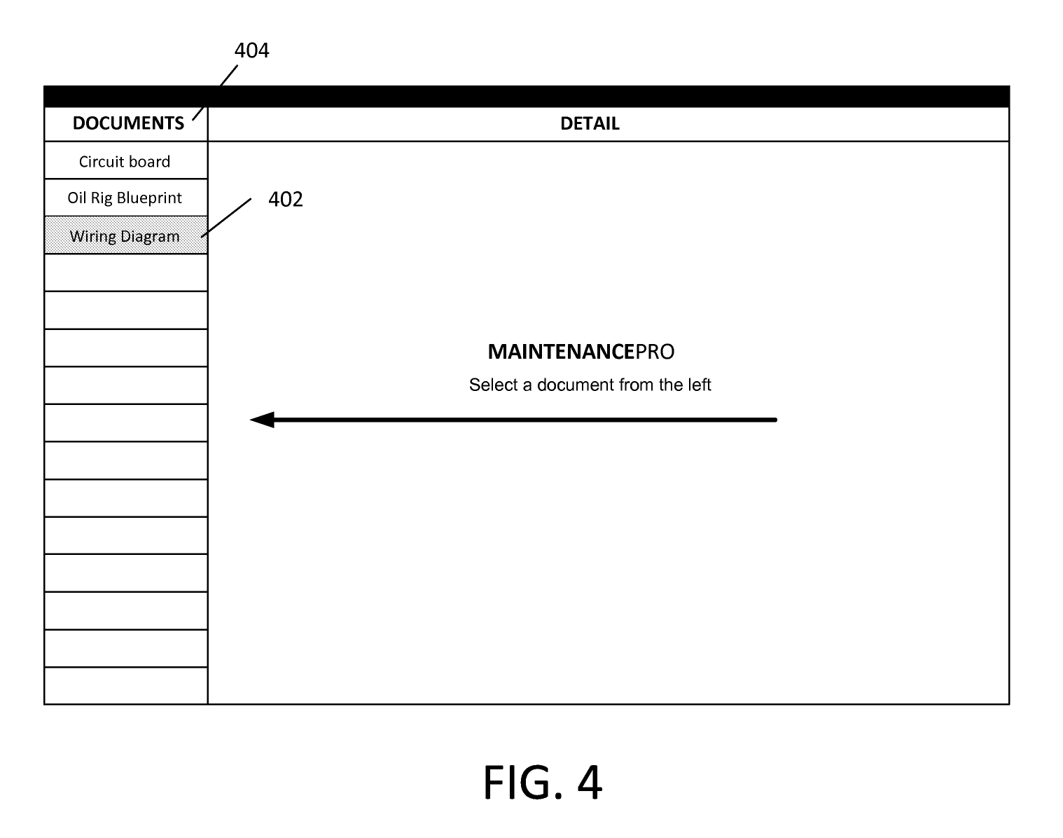

FIGS. 4-6 illustrate an example of an annotation session. In this session, the remote user at host 200 conveys to the HDM 100 the location of a broken node on a circuit board. In this example, the host 200 is an iPad device. The combination of the image data and the annotation information may be referred to herein as the “remote canvas.”

The remote user of the iPad can annotate images captured with the iPad, or select one from their image library using the add document feature. FIG. 4 illustrates the remote user selecting a wiring diagram button 402 from the document list 404. The remote user may use a mouse or other selection tool to move a cursor (not shown) to the wiring diagram button 402 to select the wiring diagram, although other ways of selecting an item within a GUI (graphical user interface) may alternatively be used.

To form a connection to the HMD 100, the remote user first adds an IP address associated with the HMD 100 in the options page of the iPad. The remote user then initiates a connection to the HMD 100 by, for example, selecting the “connect” button icon on the iPad screen, which causes the host 200 to send the selected image data to the HMD 100. When the HMD-equipped user accepts the image data, a connection is established across the wireless interface 150 between the host 200 and the HMD 100. A connection being established means that further substantive communications can occur, including packet updates and/or additional image data.

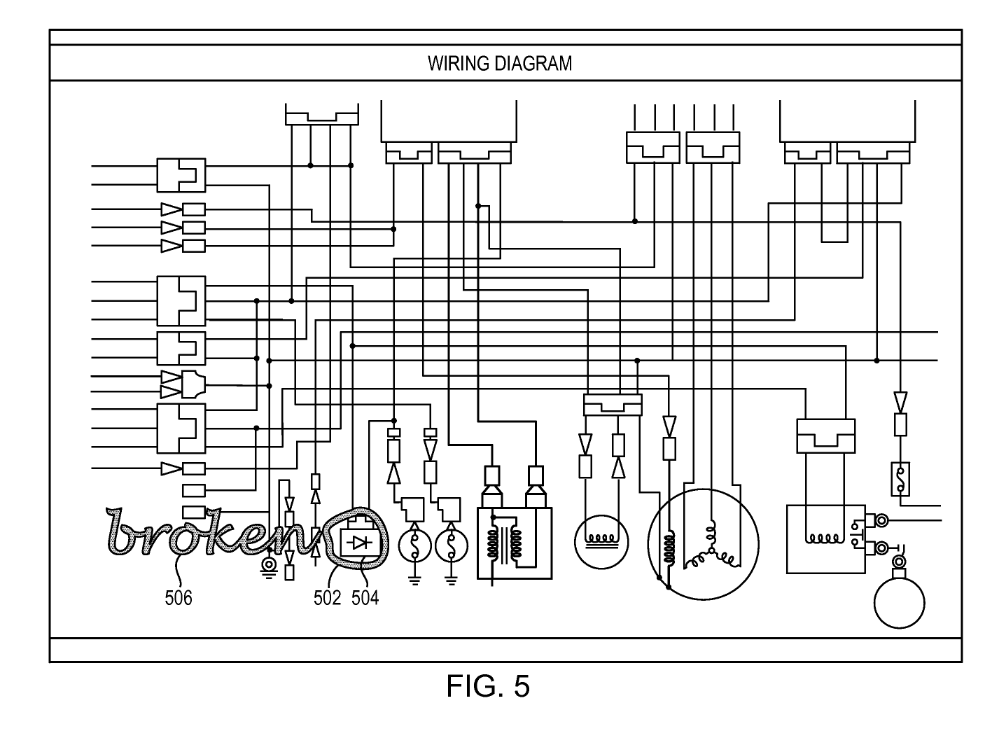

The remote user can annotate the image sent to the HMD 100 as shown on the remote canvas in FIG. 5. In this example, the remote user draws a circle 502 around a node 504 and adds the text “broken” 506 above the circle 502. The text may be written with the same stylus or other tool the remote user used to draw the circle, or the text may be typed with a keyboard, voice entry or other techniques know for entering text. The host 200 sends information about the circle 502 and the text 506 to the HMD 100 in packet updates.

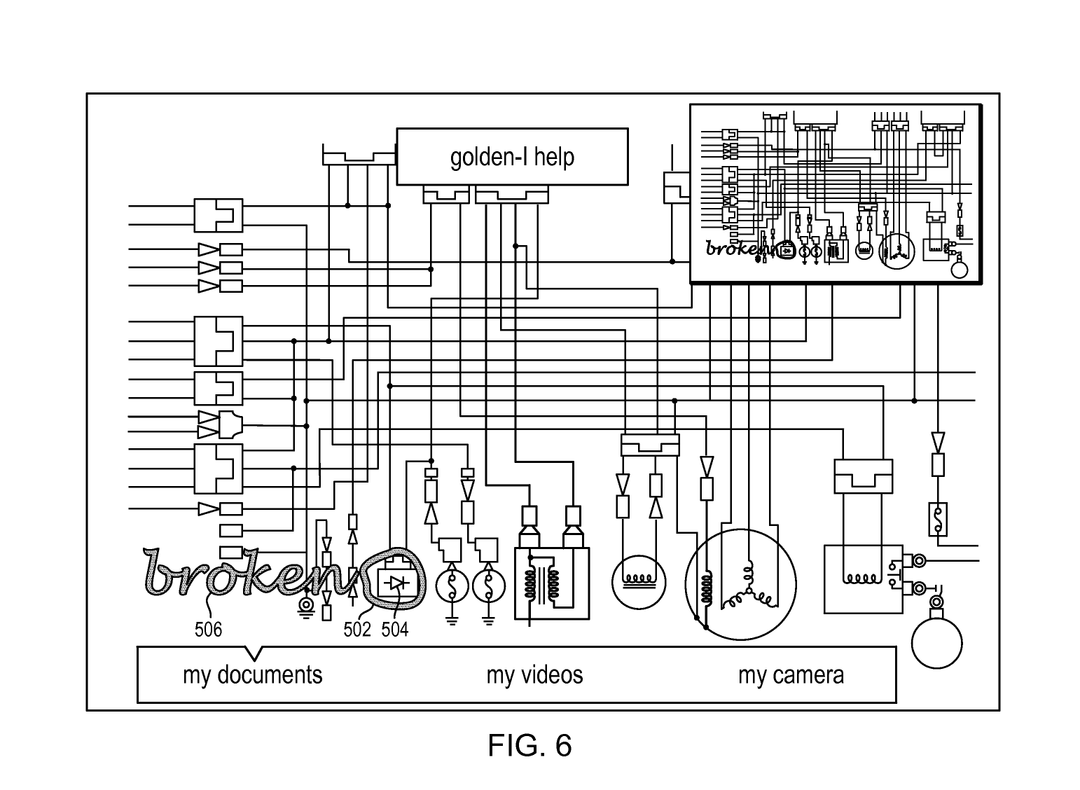

FIG. 6 illustrates the annotated document as seen from the point of view of the HMD-equipped user. For the HMD-equipped user, the canvas appears the same as a normal document, meaning that the HMD-equipped user has full document viewer functionality available in the HMD 100. As the remote user adds marks and/or text to the document, these annotations may also appear on the HMD micro-display 9010, 1010. The real-time visual communications between the HMD user and host user may be supplemented and complimented by, for example, corresponding audio communications by these users with the HMD microphone 9020 and speaker 9006 operations discussed above in FIG. 3.

In another embodiment, the HMD-equipped user may use an additional mobile device, such as a smartphone, tablet device or a laptop or notebook computer, to further annotate the document or image from the remote user. For example, when using such a mobile device locally, the HMD-equipped user may a wireless link from the HMD 100 to the additional mobile device to transfer the image or document to from the HMD 100 to the additional mobile device.

Once the image or document is on the additional mobile device, the HMD-equipped user may use an input device (e.g., a mouse, or a touch sensitive screen) to further annotate the image or document. These further annotations may be saved and/or shared with others via the wireless connection.

The wireless connection between the HMD 100 and the additional wireless device may be used to transfer the further annotations from the additional wireless device to the HMD 100 so that the HMD-equipped user can view the further annotations on the HMD micro-display 9010, 1010.

The foregoing description of embodiments is intended to provide illustration and description, but is not intended to be exhaustive or to limit the invention to the precise form disclosed. Modifications and variations are possible in light of the above teachings or may be acquired from a practice of the invention. Further, non-dependent acts may be performed in parallel. Also, the term “user,” as used herein, is intended to be broadly interpreted to include, for example, a computing device (e.g., a workstation) or a user of a computing device, unless otherwise stated.

It will be apparent that one or more embodiments, described herein, may be implemented in many different forms of software and hardware. Software code and/or specialized hardware used to implement embodiments described herein is not limiting of the invention. Thus, the operation and behavior of embodiments were described without reference to the specific software code and/or specialized hardware—it being understood that one would be able to design software and/or hardware to implement the embodiments based on the description herein.

Further, certain embodiments of the invention may be implemented as logic that performs one or more functions. This logic may be hardware-based, software-based, or a combination of hardware-based and software-based. Some or all of the logic may be stored on one or more tangible computer-readable storage media and may include computer-executable instructions that may be executed by a controller or processor, such as controller 9100. The computer-executable instructions may include instructions that implement one or more embodiments of the invention. The tangible computer-readable storage media may be volatile or non-volatile and may include, for example, flash memories, dynamic memories, removable disks, and non-removable disks.

It will be apparent that one or more embodiments described herein may be implemented in many different forms of software and hardware. Software code and/or specialized hardware used to implement embodiments described herein is not limiting of the embodiments of the invention described herein. Thus, the operation and behavior of embodiments are described without reference to specific software code and/or specialized hardware—it being understood that one would be able to design software and/or hardware to implement the embodiments based on the description herein.

Further, certain embodiments of the example embodiments described herein may be implemented as logic that performs one or more functions. This logic may be hardware-based, software-based, or a combination of hardware-based and software-based. Some or all of the logic may be stored on one or more tangible, non-transitory, computer-readable storage media and may include computer-executable instructions that may be executed by a controller or processor. The computer-executable instructions may include instructions that implement one or more embodiments of the invention. The tangible, non-transitory, computer-readable storage media may be volatile or non-volatile and may include, for example, flash memories, dynamic memories, removable disks, and non-removable disks.

While this invention has been particularly shown and described with references to example embodiments thereof, it will be understood by those skilled in the art that various changes in form and details may be made therein without departing from the scope of the invention encompassed by the appended claims.

What is claimed is:

1. A device for receiving and viewing document annotations, comprising:
a processor of a headset computer;
a micro-display driven by the processor and coupled to the headset computer; and
a receiver, coupled to the processor, configured to receive information from a remote host,
the information from the remote host includes information representative of a document and information representative of one or more annotations; and
the processor being configured to combine the information representative of a document with the information representative of one or more annotations to produce an annotated document, and display the annotated document on the micro-display.

2. The device of claim 1, wherein the receiver periodically receives query messages from the remote host, and a transmitter sends a reply message to the remote host in response to each of the query messages.

3. The device of claim 1, wherein upon receiving the information representative of a document, a transmitter conveys a decision to accept the image data to the remote host.

4. The device of claim 1, wherein upon receiving the information representative of a document, a transmitter conveys a decision to decline the image data to the remote host.

5. The device of claim 1, wherein the information representative of one or more annotations includes at least one of coordinate information, color information, line width information and text information.

6. The device of claim 1, further including an audio speaker, wherein the information from the remote host further includes audio information associated with the annotation.

7. The device of claim 1, further including a transmitter configured to transmit the annotated document to a local host.

8. The device of claim 7, wherein the receiver is further configured to receive a locally annotated version of the annotated document from the local host.

9. The device of claim 1, wherein the information from the remote host further includes one or more packet updates for supplementing initially-received information.

10. A computer-assisted method of remote document annotation, comprising:
selecting, at a host computing platform, a document to be annotated;
providing, at the host computing platform, one or more annotations to the document;
submitting, at the host computing platform, a location identifier of a desired recipient of the document;
transmitting, by the host computing platform, information representative of the document and information representative of the one or more annotations, to a head mounted display device associated with the location identifier;
receiving, by the head mounted display device, the information representative of the document and the information representative of the one or more annotations;
applying, by the head mounted display device, the information representative of the one or more annotations to the document, so as to recreate the one or more annotations provided at the host computing platform;
displaying, by the head mounted display device, the document together with the annotations.

11. The method of claim 10, further including periodically transmitting, by the host computing platform, a query message to the head mounted display device.

12. The method of claim 10, further including receiving, by the head mounted display device, the query message from the host computing platform, and transmitting, by the head mounted display device, a reply message to the host computing platform in response to the query message.

13. The method of claim 10, further including conveying, by the head mounted display device to the host computing platform, a decision to accept the information representative of the document.

14. The method of claim 10, further including transmitting the annotated document to a local host.

15. The device of claim 14, further including receiving a locally annotated version of the annotated document from the local host.

16. The method of claim 10, further including conveying, by the head mounted display device to the host computing platform, a decision to decline the information representative of the document.

17. A system for communicating document annotations, comprising:
a host computing platform, comprising:
a first processor;
a transmitter, coupled to the first processor, for transmitting information;
a head mounted display device, comprising:
a second processor;
a micro-display driven by the second processor;
a receiver, coupled to the second processor, for receiving information from the remote host;
wherein the information from the remote host includes information representative of a document and information representative of one or more annotations; and
wherein the second processor combines the information representative of a document with the information representative of one or more annotations to produce an annotated document, and displays the annotated document on the micro-display.

18. A non-transitory computer-readable medium with computer code instructions stored thereon, the computer code instructions when executed by an a processor cause a head mounted display device to:
receive information representative of (i) a document and (ii) one or more annotations;
apply the information representative of the one or more annotations to the document, so as to recreate the one or more annotations provided at the host computing platform;
display the document together with the annotations.

19. The non-transitory computer-readable medium of claim 18, the computer code instructions when executed by a processor further cause the head mounted display device to transmit the annotated document to a local host.

20. The non-transitory computer-readable medium of claim 18, the computer code instructions when executed by a processor further cause the head mounted display device to receive a locally annotated version of the annotated document from the local host.
